(19) United States
(12) Patent Application Publication
(10) Pub. No.: US 2026/0288951 A1
(43) Pub. Date: Sep. 24, 2026

(54) SYSTEMS AND METHODS FOR AUDITING USER LOGS

(71) Applicant: Strivacity, Inc., Herndon, VA (US)

(72) Inventors: Keith Martin Graham, Ashburn, VA (US); Stephen Garnett Cox, Leesburg, VA (US)

(21) Appl. No.: 19/543,401

(22) Filed: Feb. 18, 2026

Related U.S. Application Data
(60) Provisional application No. 63/759,858, filed on Feb. 18, 2025.

(51) Int. Cl. G06F 21/55; G06F 11/34; G06F 16/22; G06F 16/2457

(52) U.S. Cl. CPC G06F 21/554; G06F 11/3438; G06F 16/2237; G06F 16/24575

(57) ABSTRACT

A method for auditing user role assignments and access permissions based on user event logs from a Customer Identity and Access Management (CIAM) system includes identifying, via a generative artificial intelligence (AI) model, a plurality of target roles within the CIAM system based on organizational data retrieved from at least one database. A query is received relating to a role assignment of at least one user and data is retrieved that is contextually relevant to the query from the at least one database. The retrieved data is analyzed, via the generative AI model, to identify user activity patterns associated with the at least one user. The generative AI model determines that user access associated with the at least one user is inconsistent with at least one target role based on a comparison of the user activity patterns against expected access patterns for the at least one target role. The generative AI model generates a response to the query based on the determination. The response includes at least one of (i) a recommendation of role assignment for the at least one user and (ii) a recommendation to grant or revoke at least one access permission for the at least one user.

### CROSS-REFERENCE TO RELATED APPLICATIONS

This application claims priority to U.S. Provisional Application No. 63/759,858, filed on Feb. 18, 2025 and titled “SYSTEMS AND METHOD FOR AUDITING USER LOGS,” the entire disclosure of which is hereby incorporated by reference.

### TECHNICAL FIELD

The present disclosure relates to systems and methods for auditing user logs, and in particular to methods, devices, and systems for analyzing user event logs in Customer Identity and Access Management (CIAM) systems using generative artificial intelligence.

### BACKGROUND

User event log analysis, user account troubleshooting, and identity governance management have traditionally been manual and time-consuming tasks that require expert knowledge to interpret and take appropriate action. Customer Identity and Access Management (CIAM) systems generate and maintain various types of user logs to monitor activity, enhance security, and ensure compliance with regulatory requirements. These logs include authentication logs capturing details of login attempts, access logs tracking user sessions and resource access, account management logs documenting profile changes, security logs tracking suspicious activities, and audit logs providing records of administrative actions. While some CIAM tools use visual elements to flag suspicious users and activity, manually sifting through audit and security logs remains a significant and time-consuming process that is prone to error. Similarly, typical identity governance processes such as role assignment and access certification require significant manual effort, can be error prone, and can introduce compliance risks. When users encounter login issues, the process of determining the root cause typically involves manually examining logs, which requires significant expertise to diagnose and resolve. This can be particularly difficult for customer service representatives who often lack the required access or training to diagnose such problems.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

In various examples, the subject matter described herein relates to systems and methods for auditing user logs in Customer Identity and Access Management (CIAM) systems using generative artificial intelligence (AI). The systems and methods analyze user event logs to identify risky user activities, diagnose user login issues, and optimize identity governance processes such as role assignment and access certification. An analysis engine retrieves data contextually relevant to user queries from one or more databases using retrieval-augmented generation (RAG) techniques. A generative AI model analyzes the retrieved data to identify user activity patterns, correlate the patterns with risk indicators, login issue indicators, or target roles, and generate responses including recommendations for remedial action, troubleshooting steps, or access permission modifications.

In one aspect, a method for identifying risky user activity from user event logs in a CIAM system includes identifying, via a generative AI model, a plurality of risk indicators based on security policies and historical threat data retrieved from at least one database, receiving a query relating to risky user activity in association with the CIAM system, retrieving data that is contextually relevant to the query from the at least one database, wherein the data includes at least a portion of a user event log from the CIAM system, analyzing, via the generative AI model, the retrieved data to identify user activity patterns, wherein the generative AI model is configured to correlate the user activity patterns with the plurality of risk indicators, determining, via the generative AI model, that user activity associated with at least one user is indicative of risky behavior based on the correlation, and generating, via the generative AI model, a response to the query based on the determination, wherein the response includes an identity of the at least one user and a recommendation for remedial action.

In another aspect, a method for identifying causes of user login issues based on user event logs from a CIAM system includes identifying, via a generative AI model, a plurality of login issue indicators based on authentication policies and historical login failure data retrieved from at least one database, receiving a query relating to a login issue experienced by at least one user in association with the CIAM system, retrieving data that is contextually relevant to the query from the at least one database, wherein the data includes at least a portion of a user event log from the CIAM system, analyzing, via the generative AI model, the retrieved data to identify login activity patterns associated with the at least one user, wherein the generative AI model is configured to correlate the login activity patterns with the plurality of login issue indicators, determining, via the generative AI model, that login activity associated with the at least one user is indicative of a login issue based on the correlation, and generating, via the generative AI model, a response to the query based on the determination, wherein the response includes at least one troubleshooting step to resolve the login issue.

In yet another aspect, a method for auditing user role assignments and access permissions based on user event logs from a CIAM system includes identifying, via a generative AI model, a plurality of target roles within the CIAM system based on organizational data retrieved from at least one database, receiving a query relating to a role assignment of at least one user in association with the CIAM system, retrieving data that is contextually relevant to the query from the at least one database, wherein the data includes at least a portion of a user event log from the CIAM system, analyzing, via the generative AI model, the retrieved data to identify user activity patterns associated with the at least one user, wherein the generative AI model is configured to correlate the user activity patterns with the plurality of target roles, determining, via the generative AI model, that user access associated with the at least one user is inconsistent with at least one target role of the plurality of target roles based on a comparison of the user activity patterns against expected access patterns for the at least one target role, and generating, via the generative AI model, a response to the query based on the determination, wherein the response includes at least one of a recommendation of role assignment for the at least one user and a recommendation to grant or revoke at least one access permission for the at least one user.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a diagram of an example of a wireless measuring station, in accordance with some embodiments.

FIG. 2 is a flowchart of a method for identifying risky user activity from user event logs, in accordance with some embodiments.

FIG. 3 is a diagram of an example dashboard, in accordance with some embodiments.

FIG. 4 is a flowchart of a method for identifying the causes of user login issues, in accordance with some embodiments.

FIG. 5 is a diagram of an example dashboard, in accordance with some embodiments.

FIG. 6 is a flowchart of a method for determining optimal user role assignments and auditing user access, in accordance with some embodiments.

FIGS. 7A and 7B are diagrams of an example dashboard, in accordance with some embodiments.

FIG. 8 is a block diagram of an example computing device.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

Disclosed herein are exemplary embodiments of systems and methods for auditing user logs. In particular, described are various embodiments which use generative artificial intelligence (AI) in Customer Identity and Access Management (CIAM) systems, specifically for the analysis of user account related event logs, identifying risky user activities, diagnosing account issues, and optimizing identity governance processes.

CIAM systems are specialized systems designed to manage and secure customer identities, streamline access to digital services, and enhance user experiences. In most cases, CIAM systems focus exclusively on external users, such as customers and clients, rather than internal employees or enterprise resources. By combining robust security features with user-friendly interfaces, CIAM systems enable organizations to build secure and seamless digital interactions. The main functionalities of CIAM systems encompass customer registration and authentication processes, which include support for multiple authentication methods such as username/password combinations, social logins (e.g., via Google or Facebook), single sign-on (SSO), and password-less authentication. Identity verification is another main feature, often employing multi-factor authentication (MFA), biometric technologies, or third-party verification services to ensure the legitimacy of customer identities. Once authenticated, CIAM systems manage user access to digital resources by applying role-based or policy-based permissions to prevent unauthorized access. CIAM systems also facilitate customer profile management, enabling users to update their personal information, communication preferences, and linked accounts through centralized platforms. This capability extends to synchronizing profiles across various systems to ensure consistency.

CIAM systems generate and maintain various types of user logs to monitor activity, enhance security, and ensure compliance with regulatory requirements. Authentication logs capture details of successful and failed login attempts, including timestamps, user identifiers, authentication methods, and reasons for failure, such as incorrect credentials or failed MFA. These logs also document events like password resets, providing a comprehensive record of user authentication activities. Access logs track user sessions, recording when sessions are initiated or terminated, session durations, and associated device details. They also document which resources were accessed, the permissions granted, and instances of denied access due to insufficient privileges or policy violations. Account management logs include events like account creation, profile updates, and account deactivation or deletion. These logs detail changes to user profiles, such as updates to personal information, preferences, or linked accounts. Likewise, consent and privacy logs contribute to regulatory compliance by recording user consent for data usage, tracking data access requests, and documenting terms of service agreements, ensuring adherence to privacy laws. Security logs focus on safeguarding customer accounts by tracking suspicious activities such as multiple failed login attempts, access from unusual locations, or anomalous behaviors. These logs also record account lockouts due to repeated failed login attempts or other security concerns, as well as authentication challenges like MFA prompts issued in response to unusual login patterns. Audit logs provide detailed records of administrative actions, such as role assignments, policy updates, or system configuration changes, while also documenting policy enforcement actions and compliance checks. Analytics and insights logs aggregate data to offer usage metrics, such as peak login times, frequently accessed resources, session durations, and geolocation data. These logs also track device and browser information to aid in fraud detection and user behavior analysis. Integration logs monitor interactions with external identity providers, APIs, and authentication services, while also documenting errors or misconfigurations that impact system performance. The various types of CIAM logs described above may be referred to as “user event logs.”

User event log analysis, user account troubleshooting, and identity governance management have traditionally been manual and time-consuming tasks that require expert knowledge to interpret and take appropriate action. While some systems can provide superficial visual indicators for event successes or failures, the underlying manual effort to sift through event logs and make decisions based on historical data can lead to inefficiency and error. Similarly, typical identity governance processes such as role assignment and access certification require significant manual effort, can be error prone, and can introduce compliance risks. These challenges create a need for an improved solution that provides automatic insights, recommendations, and actions based on CIAM user logs. Accordingly, systems and methods are provided herein that utilize generative AI to analyze user event logs to identify risky activities, analyze user activity to diagnose login issues, and optimize identity governance tasks such as role assignment and access certification.

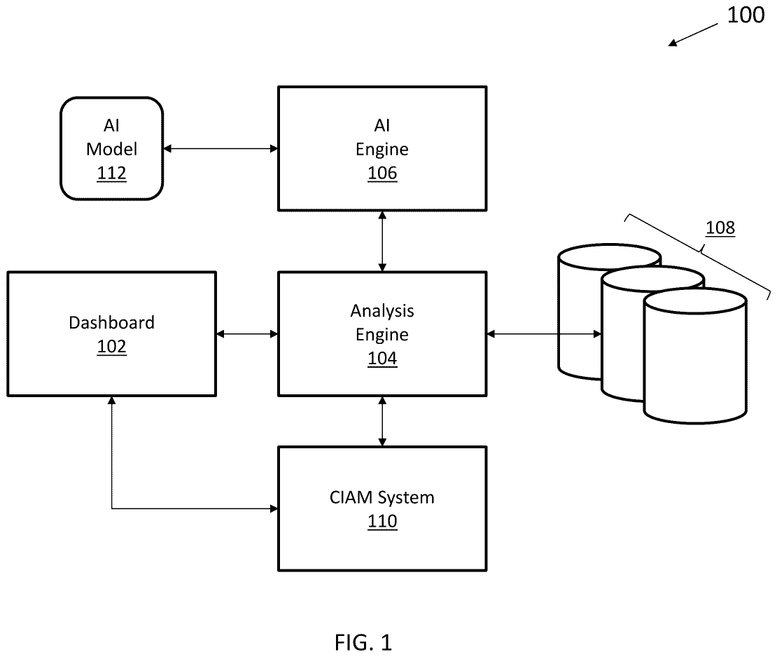

FIG. 1 is a block diagram of an event log analysis system 100 in accordance with embodiments described herein. The system 100 includes a dashboard 102, an analysis engine 104, an AI engine 106, and a plurality of databases 108. In some examples, the dashboard 102 is a user interface (UI) that enables the user (or operator) to interact with a CIAM system 110. In some examples, the dashboard 102 is a web interface accessed via a web browser. In some examples, the dashboard 102 corresponds to the UI of a standalone application or program configured to run locally on a user device or in the cloud. In some examples, the analysis engine 104 is a software component that is configured to run on one or more servers (e.g., an application server). In some examples, the analysis engine 104 is included in a standalone application with the dashboard 102.

The AI engine 106 includes, or is configured to interact with, at least one AI model 112. In some examples, the AI model 112 is a generative AI model. In some examples, the AI model 112 is a large language model (LLM). In some examples, the AI model 112 is an internal model that runs on an application server (e.g., with the analysis engine 104) or in a standalone application. In some examples, the AI model 112 is an external model that the AI engine 106 communicates with via one or more APIs. In some examples, the AI model 112 is a foundational model. In some examples, the AI model 112 is a specialized model that is trained solely for use with the system 100. The plurality of databases 108 are configured to store data used by the analysis engine 104. In some examples, the databases 108 store user information, user event logs, behavioral patterns of users, and CIAM settings and preferences. In some examples, at least a portion of the data stored in the plurality of databases 108 is vectorized or otherwise optimized for Retrieval-Augmented Generation (RAG).

Many CIAM operators (e.g., security administrators) review audit and security logs to identity risky users and signs of fraudulent activity on their platforms. While some CIAM tools use visual elements (e.g., highlighting, color-coding, etc.) to flag such users and activity, manually sifting through audit and security logs can be a significant and time consuming process, while also being prone to error.

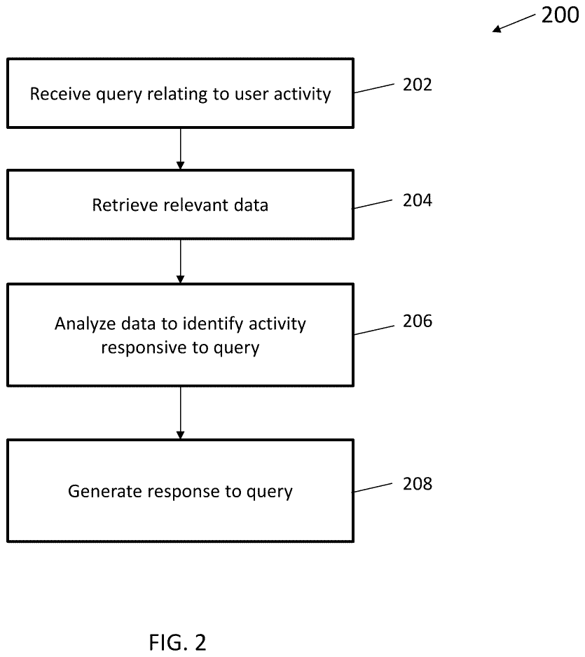

Accordingly, the system 100 is configured to analyze user event logs and automatically identify signs of risky user activity. FIG. 2 is a flowchart of a method 200 for identifying risky user activity from user event logs in accordance with aspects described herein. In some examples, the system 100 is configured to perform the method 200.

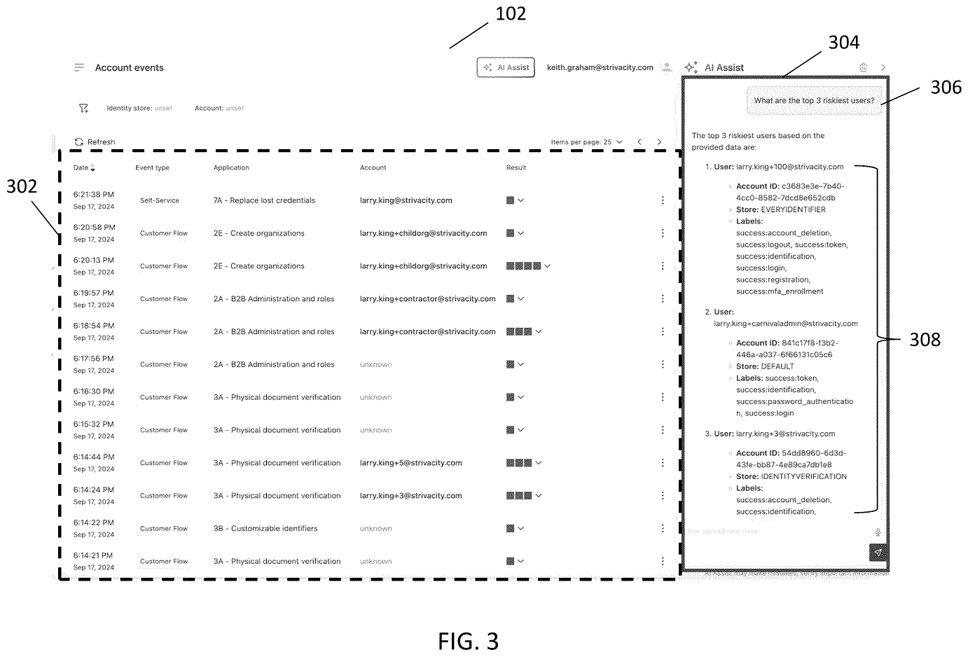

At step 202, the system 100 receives a query from a user (e.g., an administrator of the CIAM system 110). In some examples, the user provides the query via the dashboard 102. For example, FIG. 3 illustrates an example dashboard 102 that includes an interface sidebar 304. The sidebar 306 includes a natural language processing (NLP) interface that allows the user to communicate with the AI model 112. The user may enter a query 306 via the sidebar 304 (e.g., “What are the top 3 riskiest users?” or “Show me possible signs of fraud.”). In some examples, the query 306 is made with respect to a user event log 302 that is actively displayed in the dashboard 102. As such, the user may submit various queries as they browse or review the user event log 302. In some examples, the system 100 assumes that the query 306 corresponds to the actively displayed user event log 302 unless a specific event log is indicated in the query (e.g., “What are the top 3 riskiest users in Event Log 10891?”). In some examples, the query 306 includes a general query (e.g., “Who are the riskiest users?”). In some examples, the query 306 includes specific parameters for analyzing the event log 302 (e.g., “Who are the top 3 riskiest users for customer flow events?”, “Which users are causing the most physical documentation verification events?”). In some examples, the query 306 includes a threshold metric for the analysis other than “risk” (e.g., fraud).

At step 204, the system 100 retrieves data that is relevant to the query 306. In some examples, the analysis engine 104 is configured to retrieve data from the plurality of databases 108 using the query 306. In some examples, the databases 108 include documentation for the CIAM system 110 and historical data of security events and user activity. The analysis engine 104 may reformat the query 306 into a standardized form, or split the query 306 into sub-queries, before retrieving data from the databases 108. In some examples, the analysis engine 104 is configured to retrieve data using retrieval-augmented generation (RAG) techniques. For example, the analysis engine 104 may include a retrieval model optimized for RAG (e.g., a Bidirectional Encoder Representations from Transformers (BERT) model or a sentence transformer model). In some examples, the analysis engine 104 uses a vector representation of the query 306 to identify and retrieve relevant information from the databases 108 by leveraging semantic embeddings and similarity search techniques. In such examples, the query 306 is transformed into a dense vector representation using the retrieval model. In some examples, the analysis engine 104 (or the retrieval model) is configured to transform the data in the databases 108 into corresponding vector representations.

These vector representations (or embeddings) capture the semantic meaning of the text, enabling the analysis engine 104 to assess relevance based on content rather than exact word matching. For example, when the query 306 is submitted, it is encoded into a vector that represents its semantic intent. This query vector is then compared to precomputed data vectors stored in at least one database of the plurality of databases 108. In some examples, the analysis engine 104 uses similarity measures such as cosine similarity or inner product. Data with the most similar vector embeddings are retrieved as relevant (e.g., typically as the top-k results with the highest similarity scores). In some examples, the retrieved data includes at least a portion of the user event log 302. By employing vector-based representations, the analysis engine 104 can retrieve semantically relevant information even when the query 306 and the stored data use different natural language wording.

At step 206, the AI model 112 analyzes the retrieved data to identify user activity that is responsive to the query 306. In some examples, the retrieved data is combined with the query 306 by the AI engine 106 and passed as input to the AI model 112, which synthesizes a coherent and contextually informed response to the query 306. In some examples, the AI engine 106 is configured to feed the query 306 and the retrieved data to the AI model 112 using one or more prompts that instruct the AI model 112 to analyze the data based on the query 306. As described above, the AI model 112 may be a model included in the AI engine 106 or an external model that the AI engine 106 communicate with via an API. In some examples, the AI model 112 is trained iteratively (e.g., via the AI engine 106) to improve the accuracy of the model's analysis. For example, the AI model 112 may be trained using historical patterns of risky behavior that enable the model to identify similar patterns from live data. In some examples, the AI model 112 generates contextually relevant insights by applying pattern recognition algorithms trained on historical security events to identify suspicious patterns or activities in the retrieved data. Based on the identified patterns, the AI model 112 may generate actionable recommendations on how to mitigate the risks, including specific remediation steps tailored to the type of risk detected. In some examples, the analysis engine 104 is configured to automatically execute one or more remediation actions based on the output of the AI model 112, such as flagging user accounts for review, triggering additional authentication requirements, temporarily suspending suspicious accounts, or generating alerts to security administrators.

In some examples, the AI model 112 identifies expected behavior patterns by analyzing historical user activity data to establish baseline behaviors for different user categories, including typical login times, common access locations, normal resource access frequencies, and standard authentication method usage. The AI model 112 may compares current user activity against these established baselines to detect deviations that may indicate risky behavior, such as access attempts outside normal working hours, access from anomalous geographic locations, or activity patterns that deviate significantly from the user's established baseline or from peer group behaviors.

In some examples, the AI engine 106 maintains a risk indicator module that identifies a plurality of risk indicators based on organizational security policies and historical threat data stored in the plurality of databases 108. The risk indicators may include indicators derived from security policy documents, historical incident reports, and threat intelligence feeds. The AI model 112 may correlate identified user activity patterns with the plurality of risk indicators to determine whether user activity is indicative of risky behavior. Based on the correlation, the AI model 112 may generate a response that includes an identity of at least one user exhibiting risky behavior, a description of the identified risky activity, a risk severity level associated with the activity, and a recommendation for remedial action tailored to the type and severity of the risk detected.

At step 208, the analysis engine 104 generates a response to the user query 306. An example response 308 is shown in FIG. 3. In some examples, the response 308 is the direct output from the AI model 112 provided via the AI engine 106. In some examples, the analysis engine 104 is configured to format the output from the AI model 112 to improve readability and/or to match stylistic aspects of the dashboard 102. In some examples, the response 308 includes an identity of at least one user and/or a description of the identified risky activity. In some examples, the response 308 includes links that direct the dashboard user to profiles (or events) associated with the users referenced in the response 308. Likewise, the response 308 may include links to specific events or activities referenced in the response 308.

In some examples, the AI model 112 is trained using a feedback loop wherein security administrators provide labels indicating whether identified activities were true positives or false positives, thereby improving the accuracy of the model over time. The training process may include fine-tuning the AI model 112 on domain-specific CIAM log data to improve the model's ability to distinguish between legitimate user behavior and potentially malicious activity. In some examples, the AI engine 106 maintains a risk scoring module that assigns numerical risk scores to identified activities based on multiple weighted factors output by the AI model 112, including frequency of suspicious events, severity of potential impact, and correlation with known attack patterns. The risk scores may be stored in the plurality of databases 108 and used by the analysis engine 104 to prioritize alerts and automate responses based on configurable threshold values.

When users encounter login issues, the process of determining the root cause typically involves manually examining logs. In addition to being time consuming, this type of review requires significant expertise to diagnose and resolve the issue. As such, this process can be difficult for customer service representatives (CSRs) who often lack the required access or training to diagnose such problems.

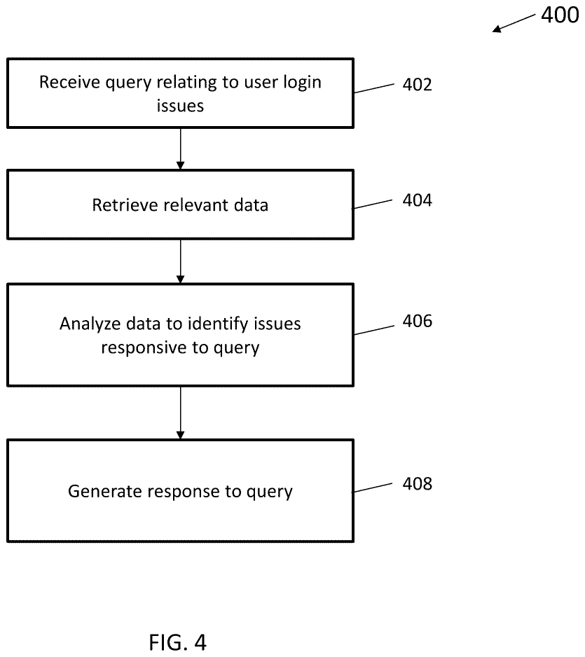

Accordingly, the system 100 is configured to analyze user event logs and automatically identify the root causes of user login issues. FIG. 4 is a flowchart of a method 400 for identifying the causes of user login issues in accordance with aspects described herein. In some examples, the system 100 is configured to perform the method 400.

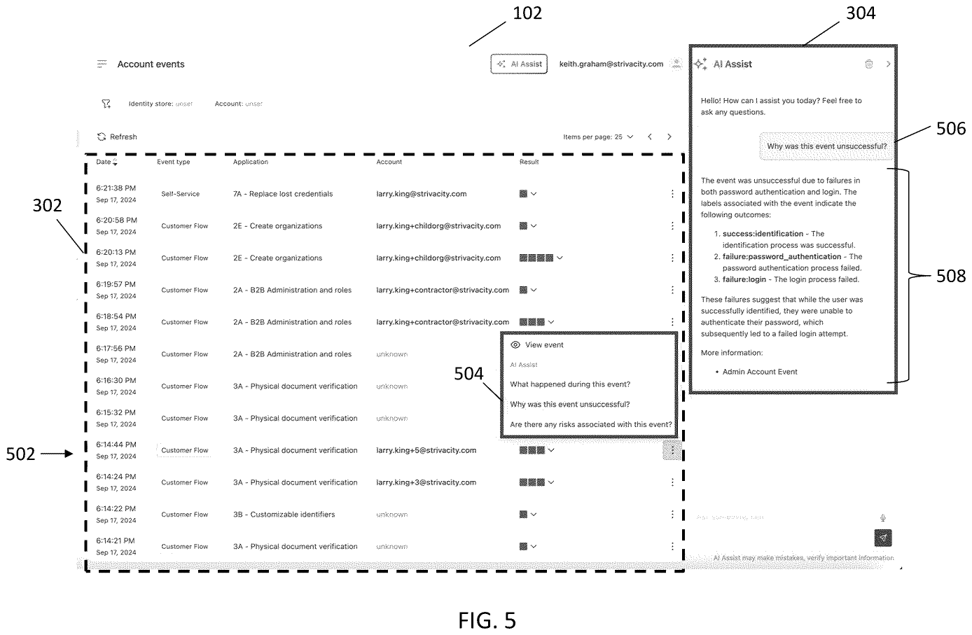

At step 402, the system 100 receives a query from a user (e.g., a CSR associated with the CIAM system 110). In some examples, the user provides the query via the dashboard 102. As shown in FIG. 5, the user may enter a query 506 via the sidebar 304 (e.g., “What was this event unsuccessful?,” “What happened during this event?,” or “Are there any risks associated with this event?”). In some examples, the query 506 is made with respect to a selected event 502 in the user event log 302. In some examples, the system 100 assumes that the query 506 corresponds to the selected event 502 unless a specific event is indicated in the query (e.g., “Why was Event 1287 unsuccessful?”). In some examples, the query 506 includes is a general query (e.g., “Why was the event unsuccessful?”). In some examples, the query 506 includes specific parameters for analyzing the event log 302 (e.g., “Was the event unsuccessful because of an issue with authentication?”). Rather than typing the query 506, the user may select a preset query from a list of queries 504. In some examples, the list of queries 504 is accessed by selecting a button associated with the event in the dashboard 102.

At step 404, the system 100 retrieves data that is relevant to the query 506. In some examples, the analysis engine 104 is configured to retrieve data from the plurality of databases 108 using the query 506. The analysis engine 104 may reformat the query 506 into a standardized form, or split the query 506 into sub-queries, before retrieving data from the databases 108. As described above, the analysis engine 104 may be configured to retrieve data using RAG techniques. In some examples, the retrieved data includes at least a portion of the user event log 302 (e.g., information related to the selected event 502). In some examples, the retrieved information includes troubleshooting documentation from the plurality of databases 108.

At step 406, the AI model 112 analyzes the retrieved data to identify issues that are responsive to the query 506. In some examples, the retrieved data is combined with the query 506 by the AI engine 106 and passed as input to the generative AI model 112, which synthesizes a coherent and contextually informed response to the query 506. In some examples, the AI engine 106 is configured to feed the query 506 and the retrieved data to the AI model 112 using one or more prompts that instruct the AI model 112 to analyze the data based on the query 506. In some examples, the AI model 112 may be trained using historical patterns of user login issues (e.g., incorrect credentials, IP address anomalies, MFA failures, etc.) and corresponding troubleshooting steps that enable the model to identify similar patterns from live data. In some examples, the AI model 112 analyzes the event activity data by parsing log entries into structured representations and applying natural language understanding techniques to extract relevant diagnostic information. The AI model 112 may cross-reference the extracted information against a knowledge base of known error conditions and troubleshooting documentation stored in the plurality of databases 108 to identify the root cause of the login failure. In some examples, the AI model 112 employs a reasoning engine that chains together multiple inference steps to trace the sequence of events leading to the login failure, enabling identification of root causes that span multiple system components. This automated diagnostic capability allows customer service teams to quickly identify issues and offer troubleshooting steps without requiring specialized technical expertise, thereby reducing the need for escalation to higher-tier support personnel. In some examples, the analysis engine 104 is configured to automatically initiate one or more corrective actions based on the output of the AI model 112, such as resetting user credentials, unlocking accounts, updating authentication policies, or sending automated instructions to the affected user.

At step 408, the analysis engine 104 generates a response to the user query 506. An example response 508 is shown in FIG. 5. In some examples, the response 508 is the direct output from the AI model 112 provided via the AI engine 106. In some examples, the analysis engine 104 is configured to format the output from the AI model 112 to improve readability and/or to match stylistic aspects of the dashboard 102. In some examples, the response 508 includes at least one troubleshooting step to resolve the login issues. In some examples, the response 508 includes links that direct the dashboard user to additional documentation for troubleshooting purposes.

In some examples, the AI model 112 is trained on a corpus of historical login failure events and their corresponding resolutions, enabling the model to learn associations between specific error patterns and effective troubleshooting steps. The training data may include labeled examples of various failure modes, including incorrect credentials, expired passwords, IP address anomalies, MFA failures, session timeouts, and device compatibility issues. In some examples, the AI engine 106 implements a confidence scoring mechanism that assigns a confidence level to each identified root cause and recommended troubleshooting step, allowing the analysis engine 104 to prioritize recommendations and determine when human review is warranted. The analysis engine 104 may maintain a resolution tracking module that records the outcomes of applied troubleshooting steps and feeds this information back to the AI engine 106 to continuously improve diagnostic accuracy.

In some examples, the AI engine 106 maintains a login issue indicator module that identifies a plurality of login issue indicators based on authentication policies and historical login failure data stored in the plurality of databases 108. The login issue indicators may be derived from authentication policy documents, historical login failure reports, and user credential management records. In some examples, the AI model 112 is configured to correlate identified login activity patterns with the plurality of login issue indicators to determine whether login activity is indicative of a login issue. The AI model 112 may establish expected authentication patterns by analyzing historical successful login data, including typical authentication sequences, normal credential validation timing, expected multi-factor authentication flows, and standard session establishment procedures. The AI model 112 may compare current login activity against these expected authentication patterns to identify deviations indicative of login issues.

In some examples, determining that login activity is indicative of a login issue includes detecting repeated failed authentication attempts, credential expiration events, multi-factor authentication failures, session timeout anomalies, device compatibility issues, or IP address anomalies. The AI model 112 may parse login event log entries into structured representations and apply natural language understanding techniques to extract authentication behavior features, enabling identification of root causes that may span multiple authentication components. The response generated by the AI model 112 may include an identification of the specific login issue, a root cause analysis tracing the sequence of events leading to the login failure, and at least one troubleshooting step to resolve the login issue, such as initiating a password reset, unlocking a user account, or escalating to technical support.

Managing user roles and access permissions is typically a manual, error-prone process that is inefficient and leads to potential security vulnerabilities if roles are improperly assigned. Likewise, access certification, typically requires periodic reviews of user access and is another time-consuming process prone to errors and omissions.

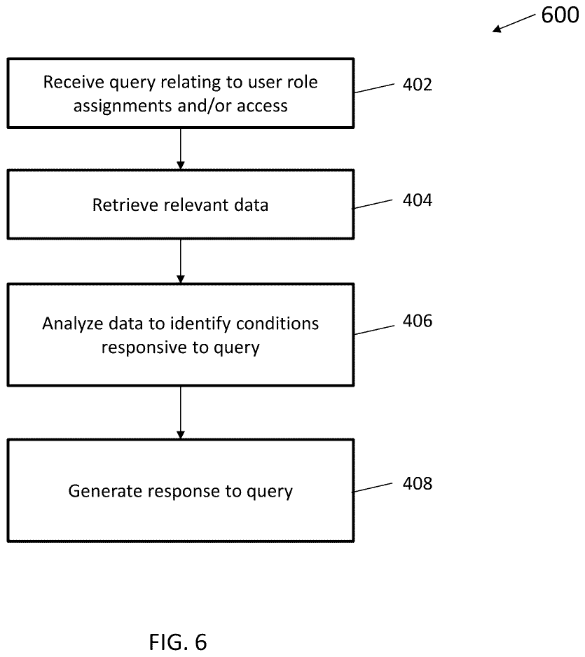

Accordingly, the system 100 is configured to analyze user role assignments and recommend optimal role assignments. In addition, the system 100 is configured to analyze event user logs to audit user access. FIG. 6 is a flowchart of a method 600 for determining optimal user role assignments and auditing user access in accordance with aspects described herein. In some examples, the system 100 is configured to perform the method 600.

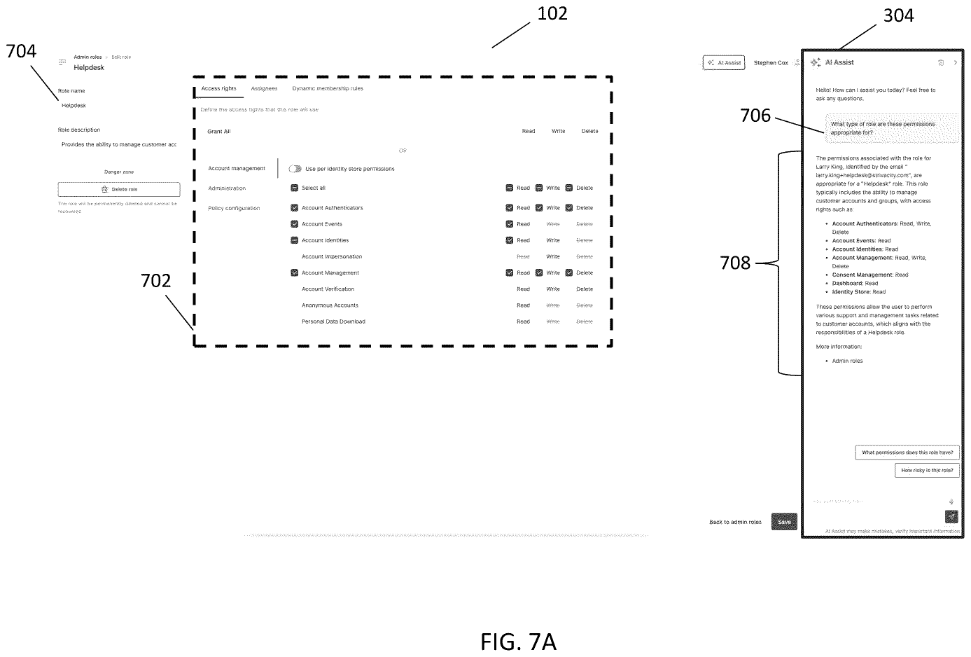

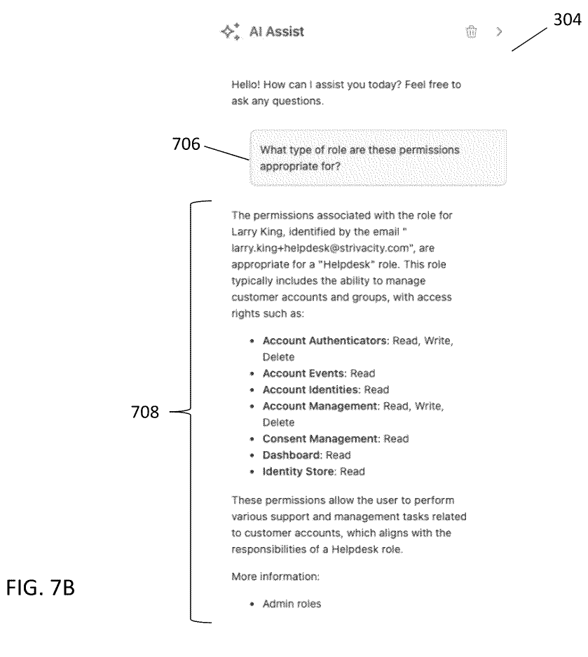

At step 602, the system 100 receives a query from a user (e.g., an administrator of the CIAM system 110). In some examples, the user provides the query via the dashboard 102. As shown in FIGS. 7A, 7B, the user may enter a query 706 via the sidebar 304 (e.g., “What type of role are these permissions appropriate for?,” “What users have access to sensitive data but shouldn't?,” or “Which users haven't used their access in the last 90 days?”). In some examples, the query 706 is made with respect to a specific user role 704 (e.g., “Helpdesk”) associated with the user event log 702. In some examples, the user event log 702 is an access log. In some examples, the system 100 assumes that the query 706 corresponds to the user role 704 unless a specific role is indicated in the query (e.g., “What permissions are appropriate for a Supervisor role?”). In some examples, the query 706 includes is a general query (e.g., “What type of role are these permissions appropriate for?”). In some examples, the query 706 includes specific parameters for analyzing the event log 702 (e.g., “Should Account Management access be activated for the Helpdesk role?”). In some examples, the query 706 is made with respect to all users in the CIAM system 110 (e.g., Which users haven't used their access in the last 90 days?). In some examples, the query 706 is made with respect to an individual user or a group of users (e.g., “Do new users from the last 30 days have the correct permissions?” or “Does User 13247 have the correct role assignment?”).

At step 604, the system 100 retrieves data that is relevant to the query 706. In some examples, the analysis engine 104 is configured to retrieve data from the plurality of databases 108 using the query 706. The analysis engine 104 may reformat the query 706 into a standardized form, or split the query 706 into sub-queries, before retrieving data from the databases 108. As described above, the analysis engine 104 may be configured to retrieve data using RAG techniques. In some examples, the retrieved data includes at least a portion of the user event log 702 (e.g., information related to the role 704). In some examples, the retrieved information includes documentation and organizational structures from the plurality of databases 108.

At step 606, the AI model 112 analyzes the retrieved data to identify conditions that are responsive to the query 706. In some examples, the retrieved data is combined with the query 706 by the AI engine 106 and passed as input to the generative AI model 112, which synthesizes a coherent and contextually informed response to the query 706. In some examples, the AI engine 106 is configured to feed the query 706 and the retrieved data to the AI model 112 using one or more prompts that instruct the AI model 112 to analyze the data based on the query 706. In some examples, the AI model 112 may be trained using historical discrepancies and patterns that suggest improperly assigned roles or excessive access rights. The AI model 112 analyzes user account event activity data by comparing current role assignments and access patterns against organizational policies, peer group behaviors, historical access utilization data, and other documentation stored in the plurality of databases 108. In some examples, the AI model 112 applies machine learning algorithms trained on organizational role hierarchies and access patterns to identify optimal role assignments that align with the principle of least privilege. In some examples, the AI model 112 flags over-privileged or incorrectly assigned users by detecting deviations from expected access patterns based on job function, department, and peer group comparisons. The AI model 112 reviews access logs to identify anomalies such as unused permissions, access to resources outside normal job scope, and dormant accounts, and generates recommendations for actions such as deactivating dormant accounts or revoking inappropriate access. By evaluating access history to identify inactive users or users with outdated permissions, the AI model 112 may generate modification recommendations to maintain compliance with organizational policies and regulatory requirements. In some examples, the analysis engine 104 is configured to automatically execute access modifications based on the output of the AI model 112, including revoking unused permissions, adjusting role assignments, deactivating dormant accounts, and generating compliance reports documenting the changes made.

At step 608, the analysis engine 104 generates a response to the user query 706. An example response 708 is shown in FIGS. 7A, 7B. In some examples, the response 708 is the direct output from the AI model 112 provided via the AI engine 106. In some examples, the analysis engine 104 is configured to format the output from the AI model 112 to improve readability and/or to match stylistic aspects of the dashboard 102. In some examples, the response 708 includes a recommendation of role assignment for at least one user and/or a recommendation to grant or revoke an access permission for at least one user. In some examples, the response 708 includes links that direct the dashboard user to additional documentation for role assignment or access certification purposes.

In some examples, the AI model 112 is trained on historical access certification data, including past decisions made by human reviewers regarding role assignments and access permissions, enabling the model to learn organizational access policies and preferences. The training process may include examples of compliant and non-compliant access configurations, allowing the AI model 112 to identify potential compliance risks before they result in violations. In some examples, the AI engine 106 implements a role mining module that analyzes patterns of resource access across users to identify candidate roles that could simplify access management and reduce the risk of over-provisioning. The analysis engine 104 may maintain an audit trail of all access modifications performed automatically or recommended by the AI model 112, including timestamps, justifications, and approval status, to support compliance reporting and regulatory audits. In some examples, the analysis engine 104 is configured to schedule periodic access reviews wherein the AI model 112 automatically evaluates all user access permissions and generates a prioritized list of recommended changes for administrator review or automatic implementation based on configurable policies.

In some examples, the AI model 112 determines that user access is inconsistent with a target role by detecting access to resources outside a normal job scope associated with the target role, unused permissions assigned to the user, or access patterns deviating from peer group behaviors. The AI model 112 may perform peer group analysis by comparing the access patterns of a user against the access patterns of other users with similar job functions, organizational positions, or role assignments. Deviations from peer group access patterns may indicate over-privileged accounts, incorrectly assigned roles, or potential security risks requiring remediation.

In some examples, the AI engine 106 maintains an issue classification module that assigns issue classifications to identified login issues, risky activities, and access inconsistencies. The issue classifications may include timestamps indicating when the issue was detected, severity levels indicating the urgency of remediation, and resolution status indicating whether the issue has been addressed. The analysis engine 104 may maintain an audit trail of all issues identified by the AI model 112, including login issues, risky activities, and access modifications. The audit trail may include timestamps, issue classifications, severity levels, remediation status, and resolution status to support compliance reporting and regulatory audits.

### SOME EMBODIMENTS

Some embodiments may include any of the following:

A1. A method for auditing user role assignments and access permissions based on user event logs from a Customer Identity and Access Management (CIAM) system, the method including identifying, via a generative artificial intelligence (AI) model, a plurality of target roles within the CIAM system based on organizational data retrieved from at least one database; receiving a query relating to a role assignment of at least one user in association with the CIAM system; retrieving data that is contextually relevant to the query from the at least one database, wherein the data includes at least a portion of a user event log from the CIAM system; analyzing, via the generative AI model, the retrieved data to identify user activity patterns associated with the at least one user, wherein the generative AI model is configured to correlate the user activity patterns with the plurality of target roles; determining, via the generative AI model, that user access associated with the at least one user is inconsistent with at least one target role of the plurality of target roles based on a comparison of the user activity patterns against expected access patterns for the at least one target role; and generating, via the generative AI model, a response to the query based on the determination, wherein the response includes at least one of (i) a recommendation of role assignment for the at least one user and (ii) a recommendation to grant or revoke at least one access permission for the at least one user.

A2. The method of clause Al can include any of the following components or features, in any combination. Retrieving data that is contextually relevant to the query from the at least one database comprises comparing vectorized representations of the query against vectorized representations of data stored in the at least one database to identify semantically relevant data. The at least one database is configured for retrieval-augmented generation (RAG). The query is received via a natural language processing (NLP) interface, and wherein the generative AI model is configured to parse the query to extract semantic intent prior to retrieving the data. Identifying the plurality of target roles includes analyzing organizational hierarchy data, job function descriptions, historical role assignment patterns, or any combination thereof, stored in the at least one database. Analyzing the retrieved data to identify user activity patterns includes parsing log entries into structured representations and applying natural language understanding techniques to extract access behavior features. Determining that user access is inconsistent with the at least one target role includes detecting at least one of access to resources outside a normal job scope associated with the at least one target role, unused permissions assigned to the at least one user, and access patterns deviating from peer group behaviors. The method includes automatically executing, via an analysis engine, at least one access modification based on the response, wherein the at least one access modification includes at least one of revoking unused permissions, adjusting role assignments, and deactivating dormant accounts. The generative AI model is trained on historical access certification data including past decisions made by human reviewers regarding role assignments and access permissions. The method includes maintaining an audit trail of all access modifications recommended by the generative AI model, wherein the audit trail includes timestamps, justifications, and approval status.

A3. A system for auditing user role assignments and access permissions based on user event logs from a Customer Identity and Access Management (CIAM) system, the system including at least one memory device with computer-executable instructions stored thereon; and at least one processor for executing the computer-executable instructions stored on the at least one memory device. Execution of the computer-executable instructions by the at least one processor causes the at least one processor to perform operations including: identifying, via a generative artificial intelligence (AI) model, a plurality of target roles within the CIAM system based on organizational data retrieved from at least one database; receiving a query relating to a role assignment of at least one user in association with the CIAM system; retrieving data that is contextually relevant to the query from the at least one database, wherein the data includes at least a portion of a user event log from the CIAM system; analyzing, via the generative AI model, the retrieved data to identify user activity patterns associated with the at least one user, wherein the generative AI model is configured to correlate the user activity patterns with the plurality of target roles; determining, via the generative AI model, that user access associated with the at least one user is inconsistent with at least one target role of the plurality of target roles based on a comparison of the user activity patterns against expected access patterns for the at least one target role; and generating, via the generative AI model, a response to the query based on the determination, wherein the response includes at least one of (i) a recommendation of role assignment for the at least one user and (ii) a recommendation to grant or revoke at least one access permission for the at least one user.

A4. A method for identifying risky user activity based on user event logs from a Customer Identity and Access Management (CIAM) system, the method including identifying, via a generative artificial intelligence (AI) model, a plurality of risk indicators based on organizational security policies and historical threat data retrieved from at least one database; receiving a query relating to activity of at least one user in association with a CIAM system; retrieving data that is contextually relevant to the query from the at least one database, wherein the data includes at least a portion of a user event log from the CIAM system; analyzing, via the generative AI model, the retrieved data to identify user activity patterns associated with the at least one user, wherein the generative AI model is configured to correlate the user activity patterns with the plurality of risk indicators; determining, via the generative AI model, that activity associated with the at least one user is indicative of risky behavior based on a comparison of the user activity patterns against expected behavior patterns derived from the plurality of risk indicators; and generating, via the generative AI model, a response to the query based on the determination, wherein the response includes at least one of (i) an identity of the at least one user, (ii) a description of the identified risky activity, and (iii) a recommendation for remedial action.

A5. The method of clause A4 can include any of the following components or features, in any combination. Retrieving data that is contextually relevant to the query from the at least one database comprises comparing vectorized representations of the query against vectorized representations of data stored in the at least one database to identify semantically relevant data. The at least one database is configured for retrieval-augmented generation (RAG). The query is received via a natural language processing (NLP) interface, and wherein the generative AI model is configured to parse the query to extract semantic intent prior to retrieving the data. Identifying the plurality of risk indicators comprises analyzing security policy documents, historical incident reports, threat intelligence feeds, or any combination thereof, stored in the at least one database. Analyzing the retrieved data to identify user activity patterns comprises parsing log entries into structured representations and applying natural language understanding techniques to extract behavioral anomaly features. Determining that activity is indicative of risky behavior comprises detecting at least one of access attempts outside normal working hours, access from anomalous geographic locations, and activity patterns deviating from established user baselines. The method includes automatically executing, via an analysis engine, at least one security action based on the response, wherein the at least one security action includes at least one of suspending user access, requiring additional authentication, and generating a security alert. The generative AI model is trained on historical security incident data including past determinations made by security analysts regarding risky user activities. The method includes maintaining an audit trail of all risky activities identified by the generative AI model, wherein the audit trail includes timestamps, risk severity levels, and remediation status.

A6. A system for identifying risky user activity based on user event logs from a Customer Identity and Access Management (CIAM) system, the system including at least one memory device with computer-executable instructions stored thereon; and at least one processor for executing the computer-executable instructions stored on the at least one memory device.

Execution of the computer-executable instructions by the at least one processor causes the at least one processor to perform operations including: identifying, via a generative artificial intelligence (AI) model, a plurality of risk indicators based on organizational security policies and historical threat data retrieved from at least one database; receiving a query relating to activity of at least one user in association with the CIAM system; retrieving data that is contextually relevant to the query from the at least one database, wherein the data includes at least a portion of a user event log from the CIAM system; analyzing, via the generative AI model, the retrieved data to identify user activity patterns associated with the at least one user, wherein the generative AI model is configured to correlate the user activity patterns with the plurality of risk indicators; determining, via the generative AI model, that activity associated with the at least one user is indicative of risky behavior based on a comparison of the user activity patterns against expected behavior patterns derived from the plurality of risk indicators; and generating, via the generative AI model, a response to the query based on the determination, wherein the response includes at least one of (i) an identity of the at least one user, (ii) a description of the identified risky activity, and (iii) a recommendation for remedial action.

A7. A method for identifying user login issues based on user event logs from a Customer Identity and Access Management (CIAM) system, the method including: identifying, via a generative artificial intelligence (AI) model, a plurality of login issue indicators based on authentication policies and historical login failure data retrieved from at least one database; receiving a query relating to a login issue of at least one user in association with the CIAM system; retrieving data that is contextually relevant to the query from the at least one database, wherein the data includes at least a portion of a user event log from the CIAM system; analyzing, via the generative AI model, the retrieved data to identify login activity patterns associated with the at least one user, wherein the generative AI model is configured to correlate the login activity patterns with the plurality of login issue indicators; determining, via the generative AI model, that login activity associated with the at least one user is indicative of a login issue based on a comparison of the login activity patterns against expected authentication patterns derived from the plurality of login issue indicators; and generating, via the generative AI model, a response to the query based on the determination, wherein the response includes at least one of (i) an identification of the login issue, (ii) a root cause analysis of the login issue, and (iii) at least one troubleshooting step to resolve the login issue.

A8. The method of clause A7 can include any of the following components or features, in any combination. Retrieving data that is contextually relevant to the query from the at least one database comprises comparing vectorized representations of the query against vectorized representations of data stored in the at least one database to identify semantically relevant data. The at least one database is configured for retrieval-augmented generation (RAG). The query is received via a natural language processing (NLP) interface, and wherein the generative AI model is configured to parse the query to extract semantic intent prior to retrieving the data. Identifying the plurality of login issue indicators includes analyzing authentication policy documents, historical login failure reports, user credential management records, or any combination thereof, stored in the at least one database. Analyzing the retrieved data to identify login activity patterns comprises parsing log entries into structured representations and applying natural language understanding techniques to extract authentication behavior features. Determining that login activity is indicative of a login issue includes detecting at least one of repeated failed authentication attempts, credential expiration events, and multi-factor authentication failures. The method includes automatically executing, via an analysis engine, at least one remediation action based on the response, wherein the at least one remediation action includes at least one of initiating a password reset, unlocking a user account, and escalating to technical support. The generative AI model is trained on historical login issue data including past resolutions implemented by support personnel regarding user authentication problems. The method includes maintaining an audit trail of all login issues identified by the generative AI model, wherein the audit trail includes timestamps, issue classifications, and resolution status.

A9. A system for identifying user login issues based on user event logs from a Customer Identity and Access Management (CIAM) system, the system including at least one memory device with computer-executable instructions stored thereon; and at least one processor for executing the computer-executable instructions stored on the at least one memory device. Execution of the computer-executable instructions by the at least one processor causes the at least one processor to perform operations including: identifying, via a generative artificial intelligence (AI) model, a plurality of login issue indicators based on authentication policies and historical login failure data retrieved from at least one database; receiving a query relating to a login issue of at least one user in association with the CIAM system; retrieving data that is contextually relevant to the query from the at least one database, wherein the data includes at least a portion of a user event log from the CIAM system; analyzing, via the generative AI model, the retrieved data to identify login activity patterns associated with the at least one user, wherein the generative AI model is configured to correlate the login activity patterns with the plurality of login issue indicators; determining, via the generative AI model, that login activity associated with the at least one user is indicative of a login issue based on a comparison of the login activity patterns against expected authentication patterns derived from the plurality of login issue indicators; and generating, via the generative AI model, a response to the query based on the determination, wherein the response includes at least one of (i) an identification of the login issue, (ii) a root cause analysis of the login issue, and (iii) at least one troubleshooting step to resolve the login issue.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that may be executed by a computer. Any suitable tangible computer readable medium may be utilized including hard disks, solid state drives, CD ROMs, optical storage devices, or magnetic storage devices.

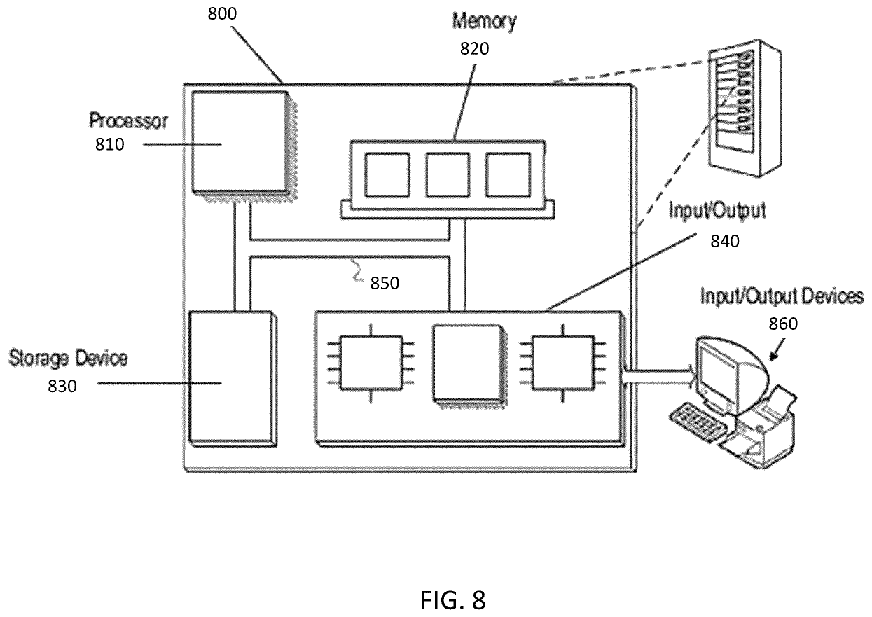

FIG. 8 shows an example of a generic computing device 800, which may be used with some of the techniques described in this disclosure. Computing device 800 includes a processor 802, memory 804, an input/output device such as a display 806, a communication interface 808, and a transceiver 810, among other components. The device 800 may also be provided with a storage device, such as a micro-drive or other device, to provide additional storage. Each of the components 800, 802, 804, 806, 808, and 810, are interconnected using various buses, and several of the components may be mounted on a common motherboard or in other manners as appropriate.

The processor 802 can execute instructions within the computing device 800, including instructions stored in the memory 804. The processor 802 may be implemented as a chipset of chips that include separate and multiple analog and digital processors. The processor 802 may provide, for example, for coordination of the other components of the device 800, such as control of user interfaces, applications run by device 800, and wireless communication by device 800.

Processor 802 may communicate with a user through control interface 812 and display interface 814 coupled to a display 806. The display 806 may be, for example, a TFT LCD (Thin-Film-Transistor Liquid Crystal Display) or an OLED (Organic Light Emitting Diode) display, or other appropriate display technology. The display interface 814 may comprise appropriate circuitry for driving the display 806 to present graphical and other information to a user. The control interface 812 may receive commands from a user and convert them for submission to the processor 802. In addition, an external interface 816 may be provided in communication with processor 802, so as to enable near area communication of device 800 with other devices. External interface 816 may provide, for example, for wired communication in some implementations, or for wireless communication in other implementations, and multiple interfaces may also be used.

The memory 804 stores information within the computing device 800. The memory 804 can be implemented as one or more of a computer-readable medium or media, a volatile memory unit or units, or a non-volatile memory unit or units. Expansion memory 818 may also be provided and connected to device 800 through expansion interface 820, which may include, for example, a SIMM (Single In Line Memory Module) card interface. Such expansion memory 818 may provide extra storage space for device 800, or may also store applications or other information for device 800. Specifically, expansion memory 818 may include instructions to carry out or supplement the processes described above, and may include secure information also. Thus, for example, expansion memory 818 may be provided as a security module for device 800, and may be programmed with instructions that permit secure use of device 800. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 804, expansion memory 818, memory on processor 802, or a propagated signal that may be received, for example, over transceiver 810 or external interface 816.

Device 800 may communicate wirelessly through communication interface 808, which may include digital signal processing circuitry where necessary. Communication interface 808 may in some cases be a cellular modem. Communication interface 808 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 810. In addition, short-range communication may occur, such as using a Bluetooth, WiFi, or other such transceiver (not shown). In addition, GPS (Global Positioning System) receiver module 822 may provide additional navigation-and location-related wireless data to device 800, which may be used as appropriate by applications running on device 800.

Device 800 may also communicate audibly using audio codec 824, which may receive spoken information from a user and convert it to usable digital information. Audio codec 824 may likewise generate audible sound for a user, such as through a speaker, e.g., in a handset of device 800. Such sound may include sound from voice telephone calls, may include recorded sound (e.g., voice messages, music files, etc.) and may also include sound generated by applications operating on device 800. In some examples, the device 800 includes a microphone to collect audio (e.g., speech) from a user. Likewise, the device 800 may include an input to receive a connection from an external microphone.

The computing device 800 may be implemented in a number of different forms, as shown in FIG. 8. For example, it may be implemented as a computer (e.g., laptop) 826. It may also be implemented as part of a smartphone 828, smart watch, tablet, personal digital assistant, or other similar mobile device.

Some implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1-20. (canceled)

21. A method for identifying risky user activity based on user event logs from a Customer Identity and Access Management (CIAM) system, the method comprising:
identifying, via a generative artificial intelligence (AI) model, a plurality of risk indicators based on organizational security policies and historical threat data retrieved from at least one database;
receiving a query relating to activity of at least one user in association with a CIAM system;
retrieving data that is contextually relevant to the query from the at least one database, wherein the data includes at least a portion of a user event log from the CIAM system;
analyzing, via the generative AI model, the retrieved data to identify user activity patterns associated with the at least one user, wherein the generative AI model is configured to correlate the user activity patterns with the plurality of risk indicators;
determining, via the generative AI model, that activity associated with the at least one user is indicative of risky behavior based on a comparison of the user activity patterns against expected behavior patterns derived from the plurality of risk indicators; and
generating, via the generative AI model, a response to the query based on the determination, wherein the response includes at least one of (i) an identity of the at least one user, (ii) a description of the identified risky activity, and (iii) a recommendation for remedial action.

22. The method of claim 21, wherein retrieving data that is contextually relevant to the query from the at least one database comprises comparing vectorized representations of the query against vectorized representations of data stored in the at least one database to identify semantically relevant data.

23. The method of claim 21, wherein the at least one database is configured for retrieval-augmented generation (RAG).

24. The method of claim 21, wherein the query is received via a natural language processing (NLP) interface, and wherein the generative AI model is configured to parse the query to extract semantic intent prior to retrieving the data.

25. The method of claim 21, wherein identifying the plurality of risk indicators comprises analyzing security policy documents, historical incident reports, threat intelligence feeds, or any combination thereof, stored in the at least one database.

26. The method of claim 21, wherein analyzing the retrieved data to identify user activity patterns comprises parsing log entries into structured representations and applying natural language understanding techniques to extract behavioral anomaly features.

27. The method of claim 21, wherein determining that activity is indicative of risky behavior comprises detecting at least one of access attempts outside normal working hours, access from anomalous geographic locations, and activity patterns deviating from established user baselines.

28. The method of claim 21, further comprising:
automatically executing, via an analysis engine, at least one security action based on the response, wherein the at least one security action includes at least one of suspending user access, requiring additional authentication, and generating a security alert.

29. The method of claim 21, wherein the generative AI model is trained on historical security incident data including past determinations made by security analysts regarding risky user activities.

30. The method of claim 21, further comprising:
maintaining an audit trail of all risky activities identified by the generative AI model, wherein the audit trail includes timestamps, risk severity levels, and remediation status.

31. A system for identifying risky user activity based on user event logs from a Customer Identity and Access Management (CIAM) system, the system comprising:
at least one memory device with computer-executable instructions stored thereon; and
at least one processor for executing the computer-executable instructions stored on the at least one memory device, wherein execution of the computer-executable instructions by the at least one processor causes the at least one processor to perform operations comprising:
identifying, via a generative artificial intelligence (AI) model, a plurality of risk indicators based on organizational security policies and historical threat data retrieved from at least one database;
receiving a query relating to activity of at least one user in association with the CIAM system;
retrieving data that is contextually relevant to the query from the at least one database, wherein the data includes at least a portion of a user event log from the CIAM system;
analyzing, via the generative AI model, the retrieved data to identify user activity patterns associated with the at least one user, wherein the generative AI model is configured to correlate the user activity patterns with the plurality of risk indicators;
determining, via the generative AI model, that activity associated with the at least one user is indicative of risky behavior based on a comparison of the user activity patterns against expected behavior patterns derived from the plurality of risk indicators; and
generating, via the generative AI model, a response to the query based on the determination, wherein the response includes at least one of (i) an identity of the at least one user, (ii) a description of the identified risky activity, and (iii) a recommendation for remedial action.

32. The system of claim 31, wherein retrieving data that is contextually relevant to the query from the at least one database comprises comparing vectorized representations of the query against vectorized representations of data stored in the at least one database to identify semantically relevant data.

33. The system of claim 31, wherein the at least one database is configured for retrieval-augmented generation (RAG).

34. The system of claim 31, wherein the query is received via a natural language processing (NLP) interface, and wherein the generative AI model is configured to parse the query to extract semantic intent prior to retrieving the data.

35. The system of claim 31, wherein identifying the plurality of risk indicators comprises analyzing security policy documents, historical incident reports, threat intelligence feeds, or any combination thereof, stored in the at least one database.

36. The system of claim 31, wherein analyzing the retrieved data to identify user activity patterns comprises parsing log entries into structured representations and applying natural language understanding techniques to extract behavioral anomaly features.

37. The system of claim 31, wherein determining that activity is indicative of risky behavior comprises detecting at least one of access attempts outside normal working hours, access from anomalous geographic locations, and activity patterns deviating from established user baselines.

38. The system of claim 31, wherein execution of the computer-executable instructions by the at least one processor causes the at least one processor to perform operations further comprising:
automatically executing, via an analysis engine, at least one security action based on the response, wherein the at least one security action includes at least one of suspending user access, requiring additional authentication, and generating a security alert.

39. The system of claim 31, wherein the generative AI model is trained on historical security incident data including past determinations made by security analysts regarding risky user activities.

40. The system of claim 31, wherein execution of the computer-executable instructions by the at least one processor causes the at least one processor to perform operations further comprising:
maintaining an audit trail of all risky activities identified by the generative AI model, wherein the audit trail includes timestamps, risk severity levels, and remediation status.

41-60. (canceled)
